(19) United States
(12) Patent Application Publication
(10) Pub. No.: US 2025/0211011 A1
(43) Pub. Date: Jun. 26, 2025

(54) BATTERY CONNECTION

(71) Applicant: VOLVO TRUCK CORPORATION, Göteborg (SE)

(72) Inventors: Emil LIDSTRÖM, Torslanda (SE); Tomas THELIN, Kärna (SE); Diego Santos Pereira NETTO, Askim (SE)

(73) Assignee: VOLVO TRUCK CORPORATION, Göteborg (SE)

(21) Appl. No.: 18/978,185

(22) Filed: Dec. 12, 2024

(30) Foreign Application Priority Data
Dec. 22, 2023 (EP) 23219717.8

(51) Int. Cl. H02J 7/00; B60L 50/60; B60L 58/10; B60R 16/023

(52) U.S. Cl. CPC H02J 7/0063; B60L 50/60; B60L 58/10; B60R 16/023; H02J 7/00304; H02J 7/0031; B60L 2240/549

(57) ABSTRACT

A computer system comprising processing circuitry is presented. The processing circuitry is configured to obtain a request indicating that an electromechanical connector arranged to selectively connect at least one battery pack to a load is to be actuated and, responsive to the request, cause control of a transistor device configured to control an electrical connection between the load, the at least one battery pack and the electromechanical connector to prevent electrical connection between the electromechanical connector and the load and/or the at least one battery pack. The processing circuitry is further configured to, after controlling the transistor device, cause actuation of the electromechanical connector in accordance with the request.

### TECHNICAL FIELD

The disclosure relates generally to electrical connections. In particular aspects, the disclosure relates to control of electrical connection in a battery. The disclosure can be applied to vehicles in general, nautical vehicles, heavy-duty vehicles, such as trucks, buses, and construction equipment, among other vehicle types. Although the disclosure may be described with respect to a particular vehicle, the disclosure is not restricted to any particular vehicle.

### BACKGROUND

Electric vehicles (EVs) are becoming increasingly popular. EVs comprise high voltage system for propelling the vehicle. These high voltage systems generally operate at voltages between 300 and 800 volts which is provided by high energy EV batteries. These voltages are significantly higher than voltages used in conventional gasoline-powered vehicles. These high voltage and energies poses a risk of overheating and damages to adjacent devices.

### SUMMARY

According to a first aspect of the disclosure, a computer system comprising processing circuitry is presented. The processing circuitry is configured to: obtain a request indicating that an electromechanical connector arranged to selectively connect at least one battery pack to a load is to be actuated; responsive to the request, cause control of a transistor device configured to control an electrical connection between the load, the at least one battery pack and the electromechanical connector to prevent electrical connection between the electromechanical connector and the load and/or the at least one battery pack; and after controlling the transistor device, cause actuation of the electromechanical connector in accordance with the request. The first aspect of the disclosure may seek to reduce a risk of arc flashes during connection or disconnection of the electromechanical connector. A technical benefit may include reduced wear of the electromechanical connector.

Optionally in some examples, including in at least one preferred example, the request is a request to actuate the electromechanical connector by closing the electromechanical connector and the processing circuitry is further configured to: obtain an indication of the electromechanical connector being closed, and responsive to the indication, control the transistor device to permit electrical connection between the load, the at least one battery pack and the electromechanical connector. A technical benefit may include further reducing a risk of arc flashes.

Optionally in some examples, including in at least one preferred example, the processing circuitry is further configured to cause control of the transistor device to provide a pre-charge current to the load. A technical benefit may include a reduced cost of the energy storage system and/or battery pack as the spacious and expensive pre-charge resistor is no longer required. Also, the pre-charge current may be adaptive and is not set by the fixed pre-charge transistor.

Optionally in some examples, including in at least one preferred example, the processing circuitry is further configured to: obtain an indication of the electromechanical connector being closed by sensing a voltage level above a voltage threshold between the transistor device and the electromechanical connector. A technical benefit may include further reducing a risk of arc flashes.

Optionally in some examples, including in at least one preferred example, the processing circuitry is further configured to: obtain a load current between the at least one battery pack and the load, responsive to the load current being above a first predetermined threshold during a first predetermined time, control the transistor device to prevent electrical connection between the load, the at least one battery pack and the electromechanical connector. A technical benefit may include providing a resettable fuse.

Optionally in some examples, including in at least one preferred example, the transistor device is arranged between the electromechanical connector and the at least one battery pack, forming part of the at least one battery pack. A technical benefit may include providing a battery pack reducing a risk of arc flashes when connected or disconnected.

Optionally in some examples, including in at least one preferred example, the transistor device is arranged between the electromechanical connector and the load, forming part of the load. A technical benefit may include providing a load reducing a risk of arc flashes when connected or disconnected to a battery pack.

Optionally in some examples, including in at least one preferred example, the request is a request to actuate the electromechanical connector by closing the electromechanical connector and the processing circuitry is further configured to: obtain an indication of the electromechanical connector being closed, and responsive to the indication, control the transistor device to permit electrical connection between the load, the at least one battery pack and the electromechanical connector; wherein the processing circuitry is further configured to: obtain an indication of the electromechanical connector being closed by sensing a voltage level above a voltage threshold between the transistor device and the electromechanical connector; wherein the processing circuitry is further configured to: obtain a load current between the at least one battery pack and the load, responsive to the load current being above a first predetermined threshold during a first predetermined time, control the transistor device to prevent electrical connection between the load, the at least one battery pack and the electromechanical connector; wherein the transistor device is arranged between the electromechanical connector and the at least one battery pack, forming part of the at least one battery pack; and wherein the battery pack is a propulsion battery pack for a vehicle. A technical benefit may include further reducing a risk of arc flashes.

According to a second aspect of the disclosure, a battery pack configured to be connected to a load via an electromechanical connector is presented. The battery pack comprising the computer system of the first aspect, at least one battery cell and a transistor device arranged to control an electrical connection between the load and the at least one battery cell. The second aspect of the disclosure may seek to reduce a risk of arc flashes during connection or disconnection of the electromechanical connector. A technical benefit may include reduced wear of the electromechanical connector.

According to a third aspect of the disclosure, an energy storage system configured to be connected to a load via an electromechanical connector is presented. The energy storage system comprising: at least one battery pack; a transistor device configured to control an electrical connection between the load, the at least one battery pack and the electromechanical connector; and the computer system of the first aspect. The third aspect of the disclosure may seek to reduce a risk of arc flashes during connection or disconnection of the electromechanical connector. A technical benefit may include reduced wear of the electromechanical connector.

Optionally in some examples, including in at least one preferred example, the battery pack is the battery pack of the second aspect.

According to a fourth aspect of the disclosure, a vehicle comprising the energy storage system of the third aspect is presented. The fourth aspect of the disclosure may seek to reduce a risk of arc flashes during connection or disconnection of the electromechanical connector. A technical benefit may include reduced wear of the electromechanical connector.

According to a fifth aspect of the disclosure, a computer implemented method is presented. The method comprising: obtaining, by processing circuitry of a computer system, a request indicating that an electromechanical connector arranged to selectively connect at least one battery pack to a load is to be actuated; responsive to the request, cause control of, by processing circuitry of the computer system, a transistor device configured to control an electrical connection between the load, the at least one battery pack and the electromechanical connector to prevent electrical connection between the load, the at least one battery pack and the electromechanical connector; and after controlling the transistor device, causing actuation, by processing circuitry of the computer system, of the electromechanical connector in accordance with the request. The fifth aspect of the disclosure may seek to reduce a risk of arc flashes during connection or disconnection of the electromechanical connector. A technical benefit may include reduced wear of the electromechanical connector.

Optionally in some examples, including in at least one preferred example, the request is a request to actuate the electromechanical connector by closing the electromechanical connector and the method further comprises: obtaining, by processing circuitry of the computer system, an indication of the electromechanical connector being closed, and responsive to the indication, controlling, by processing circuitry of the computer system, the transistor device to permit electrical connection between the load, the at least one battery pack and the electromechanical connector. A technical benefit may include further reducing a risk of arc flashes.

According to a sixth aspect of the disclosure, a computer program product is presented. The computer program product comprises program code for performing, when executed by processing circuitry, the computer implemented method of any one of the fifth aspect. The sixth aspect of the disclosure may seek to reduce a risk of arc flashes during connection or disconnection of the electromechanical connector. A technical benefit may include reduced wear of the electromechanical connector.

According to a seventh aspect of the disclosure, a non-transitory computer-readable storage medium is presented. The non-transitory computer-readable storage medium comprising instructions, which when executed by processing circuitry, cause the processing circuitry to perform the computer implemented method of the fifth aspect. The seventh aspect of the disclosure may seek to reduce a risk of arc flashes during connection or disconnection of the electromechanical connector. A technical benefit may include reduced wear of the electromechanical connector.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 is a side view of an exemplary vehicle according to an example.

FIG. 2 is a block diagram of an exemplary vehicle according to an example.

FIG. 3A is a block diagram of an exemplary sequential control circuitry according to an example.

FIG. 3B is a block diagram of an exemplary sequential control circuitry according to an example.

FIG. 3C is a block diagram of an exemplary sequential control circuitry according to an example.

FIG. 4 is an exemplary time series plot according to an example.

FIG. 5A is a schematic of an exemplary semiconductor control circuitry according to an example.

FIG. 5B is a block diagram of an exemplary semiconductor control circuitry according to an example.

FIG. 6A is a block diagram of an exemplary energy storage system according to an example.

FIG. 6B is a block diagram of a computer system according to an example.

FIG. 6C is a block diagram of a computer system according to an example.

FIG. 7 is a flow chart according to an example.

FIG. 8A is a block diagram of a method according to an example.

FIG. 8B is a block diagram of a method according to an example.

FIG. 9A is a block diagram of an exemplary vehicle according to an example.

FIG. 9B is a block diagram of an exemplary battery pack according to an example.

FIG. 10 is a schematic view of a computer program product according to an example.

FIG. 11 is a schematic diagram of an exemplary computer system for implementing examples disclosed herein, according to an example.

### DETAILED DESCRIPTION

The detailed description set forth below provides information and examples of the disclosed technology with sufficient detail to enable those skilled in the art to practice the disclosure.

As indicated, high voltage systems of electrical vehicles (EVs) require control, maintenance and security measures in place in order to ensure safe operation of the EV. For instance, even when an EV is turned off, there may still be high voltage present in the system and currents flowing from a battery of the EV. This is because batteries and capacitive loads of the EV still retain charge and there may be cooling circuitry etc. running for a period of time after EV is turned off.

In order to ensure safety of persons inside, or at a vicinity of a vehicle, numerous safety measures are generally in place such as automatic high voltage disconnect (AHVD) systems. The AHVD system will disconnect the battery from the rest of the vehicle in the event of an accident or other emergency. AHVD systems can be triggered by a variety of events, such as vehicle collisions, rollover accidents, fire, electrical problems, overheating, software glitches etc. Some AHVD systems can also be triggered manually, using a switch or button located in the vehicle. This can be useful for first responders who need to disconnect the battery pack before working on a damaged EV. Once triggered, the AHVD system generally requires professional service of the vehicle in order to be reset.

Further to the AHVD systems, electrical current paths of vehicles are generally provided with fuses configured to break in case of over currents. An issue with such fuses are that they are generally one-shots and once triggered, they have to be replaced. Such overcurrent protection fuses generally works by melting a metal strip when too much current flows through it.

In EVs, it is common to provide a mechanical connector between batteries of the EV and a load. These mechanical connector are commonly electromechanical connector such that opening and closing of the connector may be automatically controlled.

In situations where a current flows between the battery of the EV and the load, a mechanical disconnection of the battery may cause damage to the connector. When a circuit carrying a large current is broken, an arc (sometimes called arc flashes) may form between the separating contacts. Such arcs may damage a mechanical connector or even weld the mechanical connector. Mechanical switches may experience wear and erosion due to the high current levels. Over time, this wear may compromise the integrity of the mechanical contact, leading to increased resistance, overheating, and potential failure. Breaking a current carrying circuit may involve substantial mechanical forces during the breaking process. The mechanical stress on the switching components may lead to fatigue and failure over time. In a longer perspective, materials used in the mechanical contacts may release hazardous substances or contribute to environmental pollution when subjected to arcing.

Correspondingly, during a mechanical connection of the battery to the load, capacitances of the load may be charged causing significant inrush currents. This is due to a voltage at the load generally being significantly lower than a voltage of the battery (due to e.g. self-discharge of the load). High inrush currents during closing of the mechanical connector will present corresponding risks as those presented when mechanically breaking a current carrying circuit, i.e. arc flashes.

The present disclosure presents a control circuitry that, in a controlled manner, reduces a risk that a current is flowing between the battery and the load when before a mechanical connector is completely opened (substantially infinite resistance) or closed (substantially zero resistance). This significantly increase a lifetime of the mechanical connector.

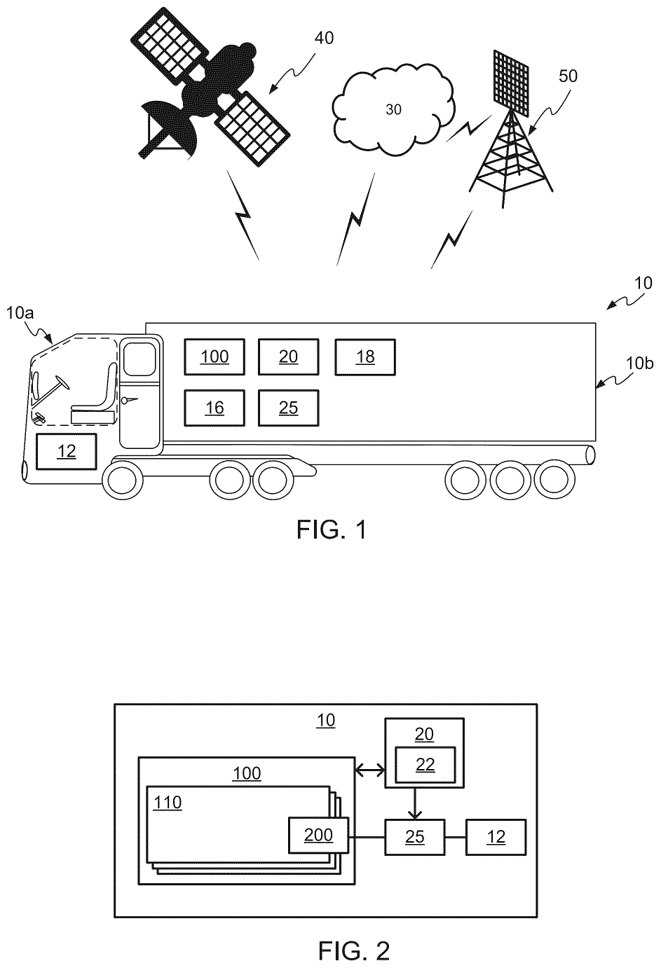

Although the sequential control circuitry of the present disclosure may be applied to any electric circuitry, examples and embodiments will be given mainly in reference to a vehicle 10, see FIG. 1. FIG. 1 is an exemplary schematic side view of a heavy-duty vehicle 10 (hereinafter referred to as vehicle 10). The vehicle 10 comprises a tractor unit 10a which is arranged to tow a trailer unit 10b. In other examples, other vehicles may be employed, e.g., trucks, buses, nautical vehicles and construction equipment. The vehicle 10 comprises all vehicle units and associated functionality to operate as expected, such as a powertrain, chassis, and various control systems. The vehicle 10 comprises one or more propulsion sources 12. The propulsion source 12 may be any suitable propulsion source 12 exemplified by, but not limited to, one or more or a combination of an electrical motor, a combustion engine such as a diesel, gas or gasoline powered engine. The vehicle 10 further comprises an energy source 100 suitable for providing energy for the propulsion source 12. That is to say, if the propulsion source 12 is an electrical motor, a suitable energy source 100 would be a battery or a fuel cell. The vehicle 10 further comprises sensor circuitry 16 arranged to detect, measure, sense or otherwise obtain data relevant for operation of the vehicle 10. The sensor circuit 16 may comprise one or more of a voltmeter, a current meter, an accelerometer, a gyroscope, a wheel speed sensor, an ABS sensor, a throttle position sensor, a fuel level sensor, a temperature sensor, a pressure sensor, a rain sensor, a light sensor, proximity sensor, a lane departure warning sensor, a blind spot detection sensor, a TPMS sensor etc. Operational data relevant for operation of the vehicle 10 may include, but is not limited to, one or more of a speed of the vehicle 10, a weight of the vehicle 10, an inclination of the vehicle 10, a status of the energy source 100 of the vehicle 10 (state of charge, fuel level etc.), a current speed limit of a current road travelled by the vehicle 10, etc. The vehicle 10 may further comprise communications circuitry 18 configured to receive and/or send communication. The communications circuitry 18 may be configured to enable the vehicle 10 to communicate with one or more external devices or systems such as a cloud server 30. The communication with the external devices or systems may be directly or via a communications interface such as a cellular communications interface 50, such as a radio base station. The cloud server 30 may be any suitable cloud server exemplified by, but not limited to, Amazon Web Services (AWS), Microsoft Azure, Google Cloud Platform (GCP), IBM Cloud, Oracle Cloud Infrastructure (OCI), DigitalOcean, Vultr, Linode, Alibaba Cloud, Rackspace etc. The communications interface may be a wireless communications interface exemplified by, but not limited to, Wi-Fi, Bluetooth, Zigbee, Z-Wave, LoRa, Sigfox, 2G (GSM, CDMA), 3G (UMTS, CDMA2000), 4G (LTE), 5G (NR) etc. The communication circuitry 18 may, additionally or alternatively, be configured to enable the vehicle 10 to be operatively connected to a Global Navigation Satellite System (GNSS) 40 exemplified by, but not limited to, global positioning system (GPS), Globalnaya Navigatsionnaya Sputnikovaya Sistema (GLONASS), Galileo, BeiDou Navigation Satellite System, Navigation with Indian Constellation (NavIC) etc. The vehicle 10 may be configured to utilize data obtain from the GNSS 40 to determine a geographical location of the vehicle 10.

The exemplary vehicle 10 of FIG. 1 is an electrical vehicle (EV) which is to mean a vehicle 10 at least partially propellable by an electrical propulsion source 12, preferably an electrical motor 12. The electrical motor 12 is powered by one or more battery packs 100. The vehicle 10 further comprise an energy storage system 20, sometimes referred to as a battery management system 20. The energy storage system 20 is configured to monitor and/or control operation of the one or more battery packs 100. The vehicle 10 further comprise an electromechanical connector 25 arranged to selectively connect the battery pack 100 to the electrical motor 12, i.e. the load 12.

In FIG. 2, a partial block diagram of a vehicle 10 according to the present disclosure is shown. The vehicle 10 comprises a battery pack 100, an electromechanical connector 25, a load 12 in the form of an electrical motor 12, and an energy storage system 20. The electromechanical connector 25 is arranged to control an electrical connection between the load 12 and the battery pack 100. In FIG. 2, the energy storage system 20 is operatively connected to the battery pack 100 and is arranged to control the electromechanical connector 25. To this end, the energy storage system 20 comprises energy storage system processing circuitry 22. In some examples, the energy storage system 20 comprise a battery pack 100. An energy storage system 20 not comprising a battery pack 100 may sometimes be referred to as an energy storage control system.

Generally, the electromechanical connector 25 is provided to allow a controlled disconnect of the battery pack 100 prior to service, replacement or other maintenance of the battery pack 100 and/or vehicle 10. An electromechanical connector 25 is to mean any connector that galvanically breaks a current path responsive to electrical controls. One example of an electromechanical connector 25 may be a relay. In some examples, the electromechanical connector 25 may be a motorized connector controllable to move e.g. a connecter in and out of galvanic contact with poles of a battery pack 100.

The battery pack 100 in FIG. 2 comprise a plurality of battery cells 110. This is one example, and in other examples, the battery pack 100 comprise only one battery cell 110. The battery cells 110 may be connected in series to allow the battery pack 100 to provide a voltage higher than a voltage of each of the battery cells 110. The battery cells 110 may be connected in parallel to allow the battery pack 100 to provide a capacitance that is higher than a capacitance of each of the battery cells 110. In some examples, the battery pack 100 comprises a plurality of sets of battery cells 110. Battery cells 110 of each set of battery cells are connected in series and the sets of battery cells are connected in parallel to provide both an increased voltage and capacitance from the battery pack 100 compared to what is offer by a single battery cell 110. Regardless of how the battery cells 110 are connected, the battery pack 100 may comprise a sequential control circuitry 200. The sequential control circuitry 200 may be connected in any current path of the battery pack 100. In the following, the sequential control circuitry 200 will be described as arranged in a current path between the battery cells 110 of the battery pack 100 and the electromechanical connector 25. However, the sequential control circuitry 200 may very well be arranged between the electromechanical connector 25 and the load 12. It should be mentioned that although the load 12 is referenced as a propulsion source of the vehicle 10, the load may very well be a non-propulsion load and the battery pack 100 a non-propulsion battery such as a 12 V or 24 V battery pack 100.

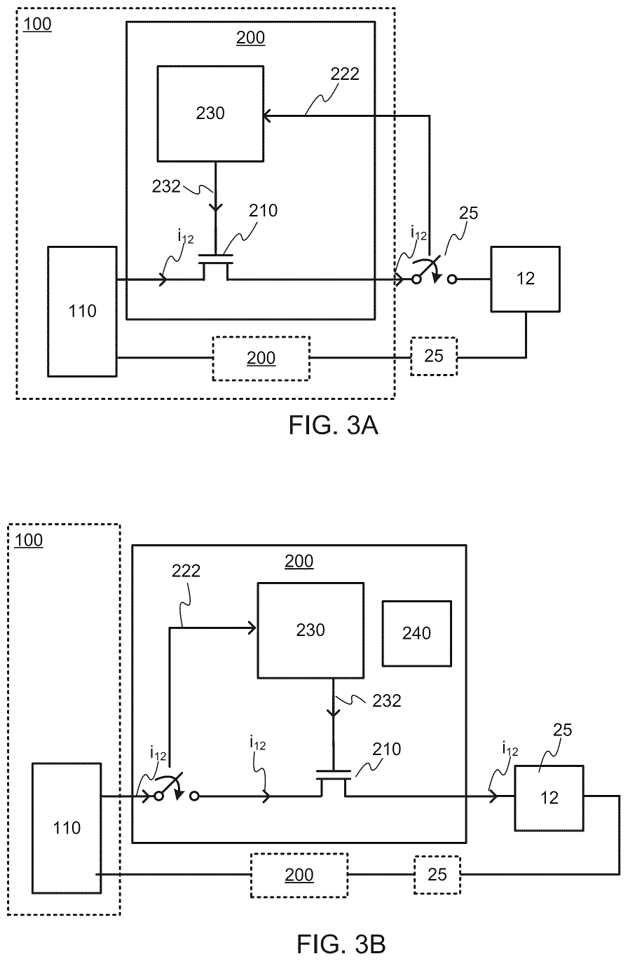

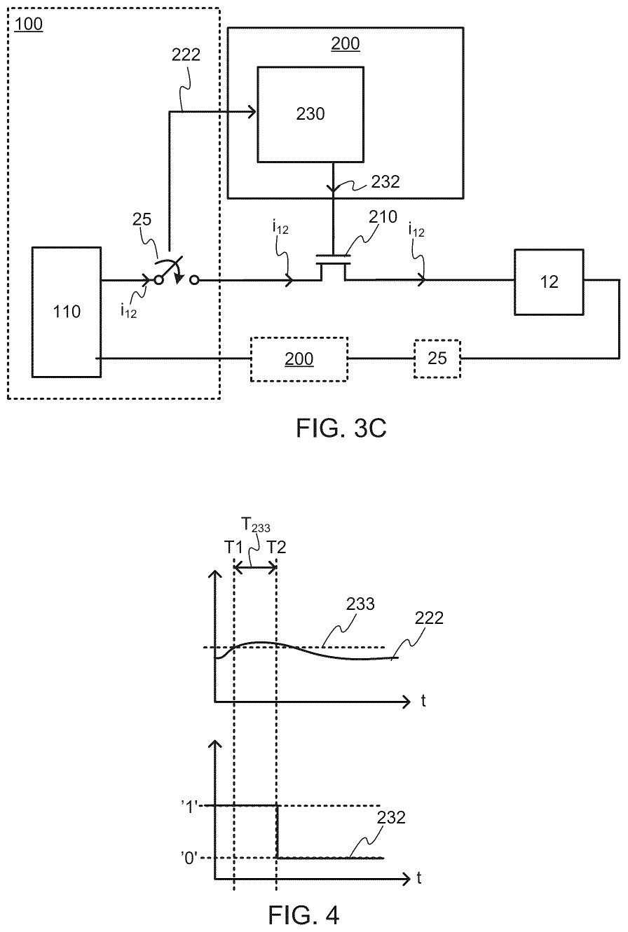

In FIG. 3A, FIG. 3B and FIG. 3C, block diagrams of exemplary sequential control circuitry 200 connected in series between one or more battery cells 110 and a load 12 are shown. The sequential control circuitry 200 of FIG. 3A, FIG. 3B and FIG. 3C differ in their respective compositions, but corresponding functionalities and effects are provided by the different sequential control circuitry 200. The sequential control circuitry 200 comprises a semiconductor control circuitry 230, is operatively connected to, or comprises, an electromechanical connector 25 and is operatively connected to, or comprises, a transistor device 210.

In FIG. 3A, FIG. 3B and FIG. 3C, the transistor device 210 is arranged to control an electrical connection between the battery cell 110 and the load 12. The transistor device 210 may be any suitable transistor device 210 exemplified by, but not limited to, a bipolar junction transistor (BJT), a field-effect transistor (FET) (e.g. junction FET, metal-oxide-semiconductor FET, metal-semiconductor FET), an insulated gate bipolar transistors (IGBT), a heterojunction bipolar transistor (HBT), etc. The selection of the particular type of transistor device 210 will generally depend on design parameters such as expected current handling capabilities (continuous current, breakable current etc.), voltage handling capabilities, switching speed etc.

The semiconductor control circuitry 230 is configured to control the transistor device 210. The semiconductor control circuitry 230 is configured to provide a control signal 232 for control of the transistor device 210. The control signal 232 is configured to control the transistor device 210 to conduct, i.e. close the electrical connection between the battery cell 110 and the load 12, or not to conduct, i.e. break the electrical connection between the battery cell 110 and the load 12. The semiconductor control circuitry 230 is configured to control the transistor device 210 based on state data 222 indicating a state change of the electromechanical connector 25. To this end, the semiconductor control circuitry 230 is operatively connected to the electromechanical connector 25 and configured to obtain state data 222 from the electromechanical connector 25. The state data 222 may be any suitable representation of a state change of the electromechanical connector 25, such as a voltage level, serial data, parallel data, voltage transitions etc. The state data 222 may be generated as part of control signals for controlling the electromechanical connector 25. Additionally, or alternatively, the state data 222 may be generated responsive to handling of devices, components or members indicating that the battery pack 100 is to be connected or disconnected. Such devices may be a handle of the battery pack 100, a cover for the battery pack 100 or the energy storage system 20. In some examples, state data 222 may be generated responsive to a hood of the vehicle 10 being opened. In some examples, state data 222 may be generated by an operator indicating that a battery pack 100 is about to be connected or disconnected.

In FIG. 3A, the transistor device 210 is arranged between the electromechanical connector 25 and the load 12. In FIG. 3A, the battery pack 100 comprises the sequential control circuitry 200 and the transistor device 25, the electromechanical connector 25 is arranged between the battery pack 100 and the load 12.

In FIG. 3B, the transistor device 210 is arranged between the electromechanical connector 25 and the battery cell 110. In FIG. 3B, the sequential control circuitry 200 is arranged between the battery pack 100 and the load 12. In FIG. 3B, the sequential control circuitry 200 comprises the transistor device 210 and the electromechanical connector 25. As seen in FIG. 3B, the sequential control circuitry 200 may comprise an internal power source 240. The internal power source 240 is only illustrated in FIG. 3B, but may very well be provided in any other example of the sequential control circuitry 200. The internal power source 240 may be any suitable power source 240 capable of providing power to the sequential control circuitry 200. The internal power source 240 may be one or more of a non-rechargeable battery, a rechargeable battery, a capacitor or a super-capacitor. In case of a rechargeable internal power source 240, the internal power source 240 may be charged from the battery cell 110 and/or any other external charger. The internal power source 240 may be a removable internal power sources 240. The internal power source 240 enables the sequential control circuitry 200 to function even if no external power is available to the sequential control circuitry 200.

It should be mentioned that, regardless if the sequential control circuitry 200 comprise the internal power source 240 or not, the sequential control circuitry 200 and the semiconductor control circuitry 230 are preferably configured such that no power is consumed in controlling the transistor device 210 to its open state, this may be referred to a normally open (NO) configuration. Such configuration ensures that the transistor device 210 would be at its open state unless actively driven to close.

In FIG. 3C, the transistor device 210 is arranged between the electromechanical connector 25 and the load 12. In FIG. 3C, the battery pack 100 comprise the electromechanical connector 25 and the transistor device 210 and sequential control circuitry 200 are stand alone.

In FIG. 3A, FIG. 3B and FIG. 3C, exemplary arrangements and compositions of the battery pack 100, the sequential control circuitry 200, the electromechanical connector 25 and the transistor device 210 have been shown. These are but examples and further arrangements and compositions may come to mind after reading the present disclosure, these compositions are arrangements are, as the skilled person will appreciate, also to be considered part of the present disclosure.

In other examples, transistor device 210 may be arranged both between the electromechanical connector 25 and the load 12, and between the electromechanical connector 25 and the battery cell 110.

As seen in FIG. 3A, FIG. 3B and FIG. 3C, the transistor device 210 may be provided in either an output and/or a return current path between the battery cell(s) 110 and the load 12. The electromechanical connector 25 may be provided in either an output and/or a return current path between the battery cell(s) 110 and the load 12.

In some examples, the sequential control circuitry 200 is configured to obtain a load current i₁₂, i.e. a current into the load 12 or into (in case of charging) the battery pack 100. The load current i₁₂ may be obtained from the previously mentioned sensor circuit 16 of the vehicle 10. The voltage drop across the transistor device 210 may be utilized together with a known on-resistance of the transistor device 210 to determine the load current i₁₂ by Ohm's law. The on-resistance may, depending on the type of transistor device, vary with temperature, control current, voltage, etc. of the transistor device 210 which is known in the art. Obtaining the load current i₁₂ enables the sequential control circuitry 200 control the transistor device to act as a resettable fuse.

In FIG. 4, exemplary time signal plots of the control signal 232 (lower graph) and the load current i₁₂ (upper graph) are shown in reference to an aligned a common time axis t. As seen in the upper graph, at a first point in time T1, the load current i₁₂ exceeds a first predetermined threshold 233. However, as seen in the lower graph of FIG. 4, the control signal 232 remains at an active or high state indicated by ‘1’ in FIG. 4. It should be noted that the naming of the e.g. the control signal 232 suggests that the transistor device 210 is active (conducting) responsive to a high control signal 232 but this is but one example and adjusting plots, circuitry, examples and embodiments of the present disclosure to be active at a low control signal 232 is, after having digested the teachings of the present disclosure, well within the knowledge of the skilled person. At a second point in time T2, the load current i₁₂ has exceeded the first predetermined threshold 233 for a first predetermined time T₂₃₃. It is not until the second point in time T2 that the control signal 232 toggles to an inactive or low state indicated by ‘0’ in FIG. 4, i.e. breaks the current path between the battery cell 110 and the load 12. Delaying the deactivation of the transistor device 210 by the first predetermined time T₂₃₃ enables triggering not only based on an absolute over current, or an amount of over energy which is the case with one-shot fuses. A one-shot fuse would generally trigger by breaking a conductor inside the one-shot fuse due to heating of the conductor. The heating of the conductor will depend on an amount of current and a time it takes for a one-shot fuse to trigger will depend on a magnitude of the overcurrent. Further, repeated current peaks above a threshold current may heat the one-shot fuse and cause it to trigger after a time. The delayed activation as presented in FIG. 4 will always trigger after the load current i₁₂ exceeding the first predetermined threshold 233 (or an indication of the load current i₁₂ exceeding the first predetermined threshold 233) for the first predetermined time T₂₃₃, regardless of how much or little or much load current i₁₂ (or the indication of the load current i₁₂) exceeds the first predetermined threshold 233.

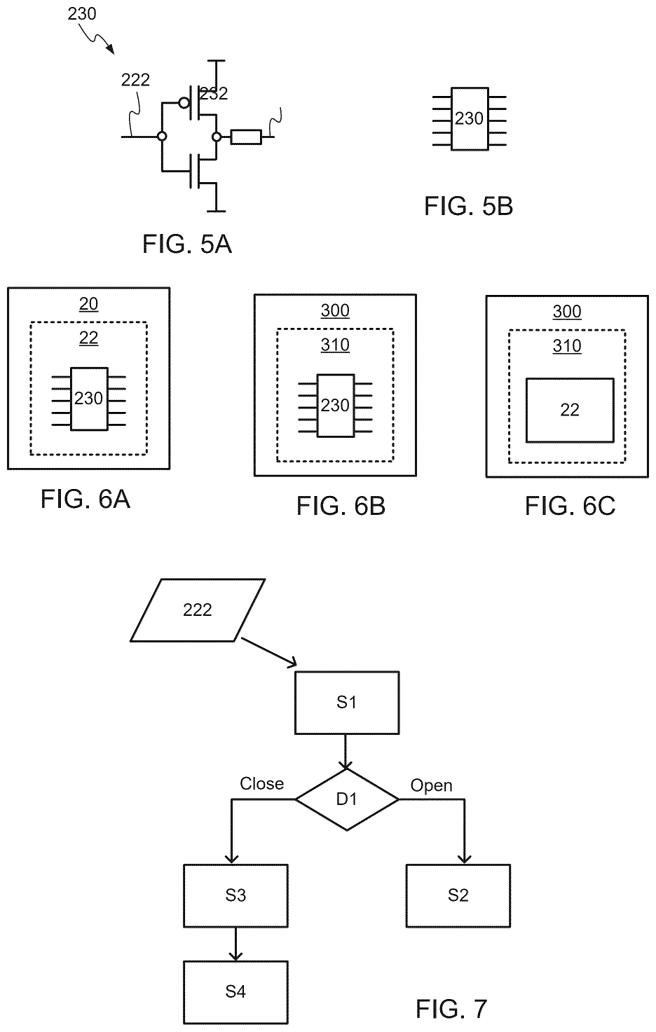

In FIG. 5A and FIG. 5B, different implementations of the semiconductor control circuitry 230 is shown. In FIG. 5A, the semiconductor control circuitry 230 is implemented as semiconductor push-pull drive circuitry 230. The commonly known push-pull architecture of the semiconductor push-pull drive circuitry 230 comprises two complementary transistor devices. These transistors operate in tandem to drive the control signal 232 quickly and efficiently. The semiconductor push-pull drive circuitry 230 configuration is but one example and alternative electric circuitry and dedicated driver ICs may very well be employed to control the transistor device 210. In FIG. 5B, the semiconductor control circuitry 230 is implemented as semiconductor control processing circuitry 230. The semiconductor control circuitry 230 of may comprise both the semiconductor push-pull drive circuitry 230 of FIG. 5A and the semiconductor control processing circuitry 230 of FIG. 5B such that the semiconductor control circuitry 230 comprise both processing circuitry and drive electronics.

The processing part of the semiconductor control circuitry 230, which may be the whole semiconductor control circuitry 230, may form part of a computer system 300. The computer system 300 comprise processing circuitry 310, and the semiconductor control processing circuitry 230 may for part of the processing circuitry 310 of the computer system 300.

In FIG. 6A, an energy storage system 20 is shown. The energy storage system processing circuitry 22 comprises the semiconductor control circuitry 230. In FIG. 6B and FIF. 5C, a computer system 300 comprising processing circuitry 310 is shown. In FIG. 6B, the processing circuitry 310 comprise the semiconductor control circuitry 230, and in FIG. 6C, the processing circuitry 310 comprise the energy storage system processing circuitry 22 (which may comprise the semiconductor control circuitry 230).

In FIG. 7, a flowchart for controlling connection and disconnection of a battery pack 100 to/from a load 12 is shown. The steps of the flowchart may be performed by the semiconductor control circuitry 230. A first step S1 is initiated by reception of state data 222 indicating that the electromechanical connector 25 is about to change state. At the first step S1, the transistor device 210 is controlled to open, i.e. stop conducting and preventing current from flowing through the electromechanical connector 25. The state data 222 is processed to, at a first decision step D1, determine if the actuation indicated by the state data 222 is opening or closing of the electromechanical connector 25. If the state data 222 indicate opening of the electromechanical connector 25, the flow proceeds to a second step S2. At step S2, the electromechanical connector 25 is controlled to open. If the state data 222 indicate closing of the electromechanical connector 25, the flow proceeds to a third step S3. At step S3, the electromechanical connector 25 is controlled to close. When the electromechanical connector 25 is closed, the flow moves to a fourth step S4 where the transistor device 210 is controlled to close, i.e. start conducting and permit current from flowing through the electromechanical connector 25. The fourth step S4 may comprise controlling the transistor device 210 to partly open in order to limit an inrush current to the load 12. In some examples, the fourth step S4 comprises controlling the transistor device 210 by pulse width modulation (PWM) to limit an inrush current to the load 12.

To ensure that the electromechanical connector 25 is truly closed when e.g. transitioning form the third step S3 to the fourth step S4, sensor circuitry 16 may be configured to detect that the electromechanical connector 25 is fully closed. In examples where the semiconductor device 210 is arranged between the electromechanical connector 25 and the load 12, such detection may be provided by detecting a voltage at an end of the electromechanical connector 25 being distal from the battery pack 100 (if the electromechanical connector 25 is closed, the battery voltage will be present also at the distal end of the electromechanical connector 25). In examples where the semiconductor device 210 is arranged between the electromechanical connector 25 and the battery pack 100, such detection may be provided by applying voltage at one end of the electromechanical connector 25 and detecting the voltage at the opposite end of the electromechanical connector 25. Alternatively, or additionally, the transistor device 210 may be controlled to operate at a current limiting mode where e.g. PWM control or linear control is employed to limit a current through the transistor device 210. The latter example may be combined with sensor circuitry 16 configured to detect the voltage at an end of the electromechanical connector 25 being distal from the battery pack 100 or a current into the electromechanical connector 25. The voltage may be detected by comparing the obtained voltage to a threshold, if the obtained voltage is above the threshold, the electromechanical connector 25 is determined to be closed.

Generally, if the load 12 comprises an electrical motor with associated control circuitry such as inverters etc., the load 12 will exhibit a substantial capacitance to a battery pack 100 and/or battery cells 110 connected to the load 12. If the capacitances of the load 12 are substantially discharged, the capacitances of the load 12 will cause a significant inrush current upon connection of the battery pack 100 to the load 12. To reduce a magnitude of the inrush current, the electrical current path between the battery pack 100 and/or battery cells 110 may be provided with a selectively connectable pre-charge circuitry. The pre-charge circuitry generally comprise at least one switch arranged to selectively connect a pre-charge resistor in a current path between the battery cells 110 and the load 12 or to bypass the pre-charge resistor. However, the pre-charge resistor is a comparably expensive component as it is required to dissipate significant amount of heat in order to keep a time for pre-charge short which means that pre-charge resistors are generally both large and expensive. However, as indicated with reference to e.g. FIG. 3A, FIG. 3B or FIG. 3C, the sequential control circuitry 200 of the present disclosure may be configured to control and limit the load current i₁₂. To this end, sequential control circuitry 200 provide a pre-charge functionality, i.e. limit the load current i₁₂ by PWM or linear control of the transistor device 210. In other words, the sequential control circuitry 200 and the semiconductor control circuitry 230 may be configured to replace a pre-charge resistor between battery cells 110 and a load 12. The sequential control circuitry 200 may consequently reduce a cost of a battery pack 100, a energy storage system 20 and/or a vehicle 10 depending on where a pre-charge resistor would have been arranged.

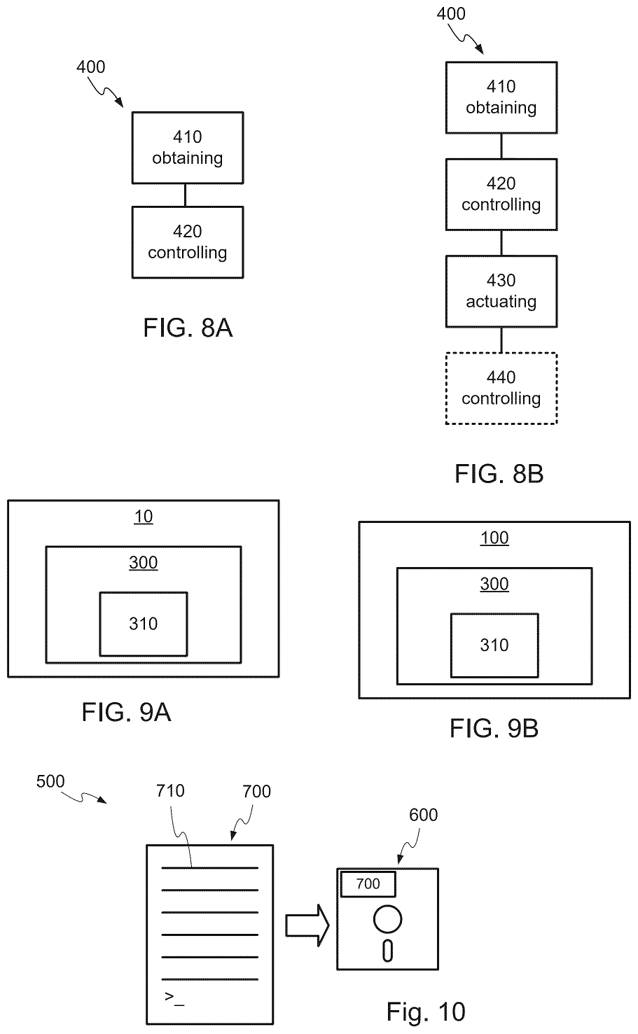

In FIG. 8A and FIG. 8B, a schematic views of examples of a method 400 according to the present disclosure is shown. The method 600 may be a computer implemented method 600 performed by e.g. the semiconductor control processing circuitry 230, the energy storage system processing circuitry 22 or the processing circuitry 310 of the computer system 300.

The method 400 in n FIG. 8A may be performed by the semiconductor control circuitry 230 of FIG. 5A or FIG. 5B. The method 400 comprises obtaining 410 a request 222 indicating that the electromechanical connector 25 is to be actuated. The method 400 further comprises, responsive to the request 222 controlling the transistor device 210 to open, i.e. stop conducting. This means that, depending on where the transistor device 210 is arranged, electrical connection either between the electromechanical connector 25 and the battery pack 100 or between the electromechanical connector 25 and the load 12 is prevented by the transistor device 210. Regardless if the request 222 indicates that the electromechanical connector 25 is to be opened or closed, this may be done without risk of arc flashes as the open transistor device 210 prevents current from flowing through the electromechanical connector 25.

The method 400 in n FIG. 8B may be partly performed by the semiconductor control circuitry 230 of FIG. 5A or wholly by the semiconductor control circuitry 230 of FIG. 5B. The method 400 comprises causing obtaining 410 of, or obtaining, a request 222 indicating that the electromechanical connector 25 is to be actuated. The method 400 further comprises, responsive to the request 222 controlling 420, or causing control of, the transistor device 210 to open, i.e. stop conducting. This means that, depending on where the transistor device 210 is arranged, electrical connection either between the electromechanical connector 25 and the battery pack 100 or between the electromechanical connector 25 and the load 12 is prevented by the transistor device 210. The method 400 further comprises actuating 430, or causing actuation of, the electromechanical connector 25 as indicated by the request 222. This means that, if the request 222 indicates opening of the electromechanical switch 25, actuating 430 the electromechanical connector 25 comprises opening (or causing opening of) the electromechanical switch 25. Further, if the request 222 indicates closing of the electromechanical switch 25, actuating 430 the electromechanical connector 25 comprises closing (or causing closing of) the electromechanical switch 25. Optionally, if the request 222 indicates closing of the electromechanical switch 25, the method 400 may further comprise, after closing of the electromechanical connector 25, controlling 440, or causing control of, the transistor device 210 to close, i.e. to permit current to flow through the electromechanical connector 25.

The method 400 presented with reference to FIG. 8B may very well me expanded to include any suitable example, feature or effect presented herein.

The computer system 300 previously presented, or rather the processing circuitry 310 of the computer system 300 is advantageously configured to perform the method 400. In FIG. 9A, a vehicle 10 comprising the computer system 300 is shown and in FIG. 9B, a battery pack 100 comprising the computer system 300 is shown.

In FIG. 10 a computer program product 500 is shown. The computer program product 500 comprises a computer program 700 and a non-transitory computer readable medium 600. The computer program 700 may be stored on the computer readable medium 600. The computer readable medium 600 is, in FIG. 10, exemplified as a vintage 5,25″ floppy disc, but may be embodied as any suitable non-transitory computer readable medium such as, but not limited to, hard disk drives (HDDs), solid-state drives (SSDs), optical discs (e.g., CD-ROM, DVD-ROM, CD-RW, DVD-RW), USB flash drives, magnetic tapes, memory cards, Read-Only Memories (ROM), network-attached storage (NAS), cloud storage etc.

The computer program 700 comprises instruction 710 e.g. program instruction, software code, that, when executed by processing circuitry cause the processing circuitry to perform the method 400 introduced with reference to FIG. 8A or FIG. 8B.

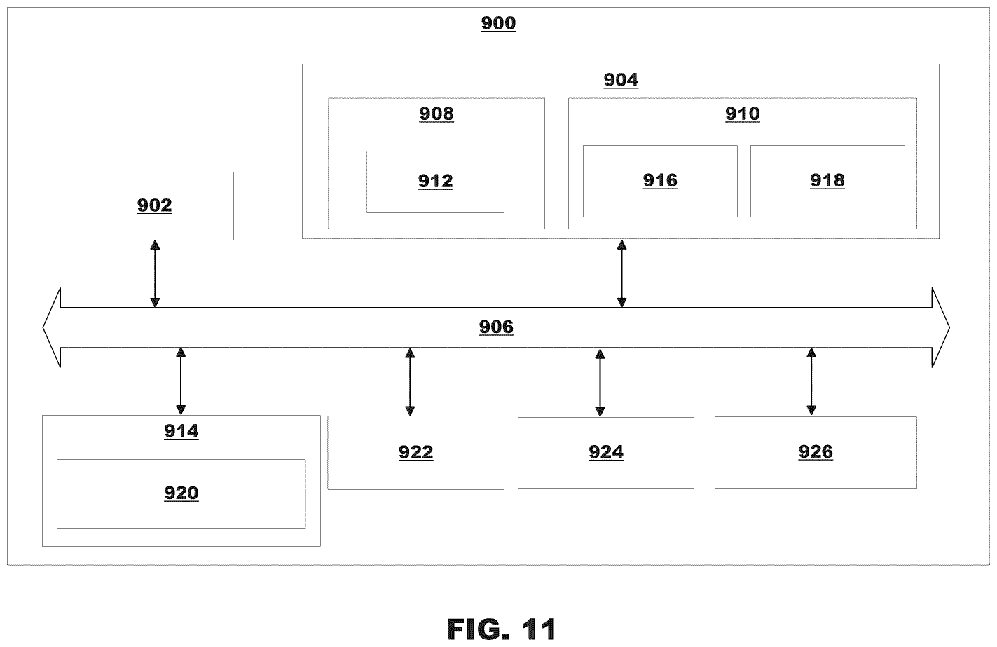

FIG. 11 is a schematic diagram of a computer system 900 for implementing examples disclosed herein. The computer system 900 is adapted to execute instructions from a computer-readable medium to perform these and/or any of the functions or processing described herein. The computer system 900 may be connected (e.g., networked) to other machines in a LAN, an intranet, an extranet, or the Internet. While only a single device is illustrated, the computer system 900 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 900 may comprise at least one computing device or electronic device capable of including firmware, hardware, and/or executing software instructions to implement the functionality described herein. The computer system 900 may include processing circuitry 902 (e.g., processing circuitry including one or more processor devices or control units), a memory 904, and a system bus 906. The computer system 900 may include at least one computing device having the processing circuitry 902. The system bus 906 provides an interface for system components including, but not limited to, the memory 904 and the processing circuitry 902. The processing circuitry 902 may include any number of hardware components for conducting data or signal processing or for executing computer code stored in memory 904. The processing circuitry 902 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 902 may further include computer executable code that controls operation of the programmable device.

The system bus 906 may be any of several types of bus structures that may further interconnect to a memory bus (with or without a memory controller), a peripheral bus, and/or a local bus using any of a variety of bus architectures. The memory 904 may be one or more devices for storing data and/or computer code for completing or facilitating methods described herein. The memory 904 may include database components, object code components, script components, or other types of information structure for supporting the various activities herein. Any distributed or local memory device may be utilized with the systems and methods of this description. The memory 904 may be communicably connected to the processing circuitry 902 (e.g., via a circuit or any other wired, wireless, or network connection) and may include computer code for executing one or more processes described herein. The memory 904 may include non-volatile memory 908 (e.g., read-only memory (ROM), erasable programmable read-only memory (EPROM), electrically erasable programmable read-only memory (EEPROM), etc.), and volatile memory 910 (e.g., random-access memory (RAM)), or any other medium which can be used to carry or store desired program code in the form of machine-executable instructions or data structures and which can be accessed by a computer or other machine with processing circuitry 902. A basic input/output system (BIOS) 912 may be stored in the non-volatile memory 908 and can include the basic routines that help to transfer information between elements within the computer system 900.

The computer system 900 may further include or be coupled to a non-transitory computer-readable storage medium such as the storage device 914, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 914 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 914 and/or in the volatile memory 910, which may include an operating system 916 and/or one or more program modules 918. All or a portion of the examples disclosed herein may be implemented as a computer program 920 stored on a transitory or non-transitory computer-usable or computer-readable storage medium (e.g., single medium or multiple media), such as the storage device 914, which includes complex programming instructions (e.g., complex computer-readable program code) to cause the processing circuitry 902 to carry out actions described herein. Thus, the computer-readable program code of the computer program 920 can comprise software instructions for implementing the functionality of the examples described herein when executed by the processing circuitry 902. In some examples, the storage device 914 may be a computer program product (e.g., readable storage medium) storing the computer program 920 thereon, where at least a portion of a computer program 920 may be loadable (e.g., into a processor) for implementing the functionality of the examples described herein when executed by the processing circuitry 902. The processing circuitry 902 may serve as a controller or control system for the computer system 900 that is to implement the functionality described herein.

The computer system 900 may include an input device interface 922 configured to receive input and selections to be communicated to the computer system 900 when executing instructions, such as from a keyboard, mouse, touch-sensitive surface, etc. Such input devices may be connected to the processing circuitry 902 through the input device interface 922 coupled to the system bus 906 but can be connected through other interfaces, such as a parallel port, an Institute of Electrical and Electronic Engineers (IEEE) 1394 serial port, a Universal Serial Bus (USB) port, an IR interface, and the like. The computer system 900 may include an output device interface 924 configured to forward output, such as to a display, a video display unit (e.g., a liquid crystal display (LCD) or a cathode ray tube (CRT)). The computer system 900 may include a communications interface 926 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

Example 1. A computer system 300 comprising processing circuitry 310 configured to: obtain a request 222 indicating that an electromechanical connector 25 arranged to selectively connect at least one battery pack 100 to a load 12 is to be actuated; responsive to the request, cause control of a transistor device 210 configured to control an electrical connection between the load 12, the at least one battery pack 100 and the electromechanical connector 25 to prevent electrical connection between the electromechanical connector 25 and the load 12 and/or the at least one battery pack 100; and after controlling the transistor device 210, cause actuation of the electromechanical connector 25 in accordance with the request 222.

Example 2. The computer system 300 of example 1, wherein the request 222 is a request to actuate the electromechanical connector 25 by opening the electromechanical connector 25.

Example 3. The computer system 300 of example 1, wherein the request 222 is a request to actuate the electromechanical connector 25 by closing the electromechanical connector 25.

Example 4. The computer system 300 of example 3, wherein the processing circuitry 310 is further configured to: obtain an indication of the electromechanical connector 25 being closed, and responsive to the indication, control the transistor device 210 to permit electrical connection between the load 12, the at least one battery pack 100 and the electromechanical connector 25.

Example 5. The computer system 300 of example 4, wherein the processing circuitry 310 is further configured to: obtain an indication of the electromechanical connector 25 being closed by sensing a voltage level above a voltage threshold between the transistor device 210 and the electromechanical connector 25.

Example 6. The computer system 300 of any one of example 1 to 5, wherein the processing circuitry 310 is further configured to: obtain a load current i₁₂ between the at least one battery pack 100 and the load 12, responsive to the load current i₁₂ being above a first predetermined threshold 233 during a first predetermined time T₂₃₃, control the transistor device 210 to prevent electrical connection between the load 12, the at least one battery pack 100 and the electromechanical connector 25.

Example 7. The computer system 300 of any one of example 1 to 6, wherein the transistor device 210 is arranged between the electromechanical connector 25 and the at least one battery pack 100, forming part of the at least one battery pack 100.

Example 8. The computer system 300 of any one of example 1 to 6, wherein the transistor device 210 is arranged between the electromechanical connector 25 and the load 12, forming part of the load 12.

Example 9. The computer system 300 of example 1, wherein the request 222 is a request to actuate the electromechanical connector 25 by closing the electromechanical connector 25; wherein the processing circuitry 310 is further configured to: obtain an indication of the electromechanical connector 25 being closed, and responsive to the indication, control the transistor device 210 to permit electrical connection between the load 12, the at least one battery pack 100 and the electromechanical connector 25; wherein the processing circuitry 310 is further configured to: obtain an indication of the electromechanical connector 25 being closed by sensing a voltage level above a voltage threshold between the transistor device 210 and the electromechanical connector 25; wherein the processing circuitry 310 is further configured to: obtain a load current i₁₂ between the at least one battery pack 100 and the load 12, responsive to the load current i₁₂ being above a first predetermined threshold 233 during a first predetermined time T₂₃₃, control the transistor device 210 to prevent electrical connection between the load 12, the at least one battery pack 100 and the electromechanical connector 25; wherein the transistor device 210 is arranged between the electromechanical connector 25 and the at least one battery pack 100, forming part of the at least one battery pack 100.

Example 10. A battery pack 100 configured to be connected to a load 12 via an electromechanical connector 25, the battery pack 100 comprising the computer system 300 of any of example 1 to 7, at least one battery cell 110 and a transistor device 210 arranged to control an electrical connection between the load 12 and the at least one battery cell 110.

Example 11. The battery pack 100 of example 10, wherein the transistor device 210 is configured as normally open, NO.

Example 12. The battery pack 100 of example 11, wherein the transistor device 210 is configured to prevent electrical connection between the load 12 and the at least one battery cell 110 unless an indication of the electromechanical connector 25 being closed is obtained.

Example 13. An energy storage system 20 configured to be connected to a load 12 via an electromechanical connector 25, the energy storage system 20 comprising: at least one battery pack 100, a transistor device 210 configured to control an electrical connection between the load 12, the at least one battery pack 100 and the electromechanical connector 25, and the computer system 300 of any of example 1 to 6.

Example 14. The energy storage system 20 of example 13, wherein the battery pack 100 is the battery pack 100 of any one of examples 10 to 12.

Example 15. A vehicle 10 comprising the energy storage system 20 of example 13 or 14.

Example 16. A computer implemented method 400 comprising: obtaining 410, by processing circuitry 310 of a computer system 300, a request 222 indicating that an electromechanical connector 25 arranged to selectively connect at least one battery pack 100 to a load 12 is to be actuated; responsive to the request 222, cause control 420 of, by processing circuitry 310 of the computer system 300, a transistor device 210 configured to control an electrical connection between the load 12, the at least one battery pack 100 and the electromechanical connector 25 to prevent electrical connection between the electromechanical connector 25 and the load 12 and/or the at least one battery pack 100, and after controlling the transistor device 210, causing actuation 430, by processing circuitry 310 of the computer system 300, of the electromechanical connector 25 in accordance with the request 222.

Example 17. The computer implemented method 400 of example 16, wherein the request 222 is a request to actuate the electromechanical connector 25 by closing the electromechanical connector 25 and the method further comprises: obtaining, by processing circuitry 310 of the computer system 300, an indication of the electromechanical connector 25 being closed, and responsive to the indication, controlling, by processing circuitry 310 of the computer system 300, the transistor device 210 to permit electrical connection between the load 12, the at least one battery pack 100 and the electromechanical connector 25.

Example 18. The computer implemented method 400 of example 16 or 17, further comprising: obtaining, by processing circuitry 310 of the computer system 300, a load current i₁₂ between the at least one battery pack 100 and the load 12, determining, by processing circuitry 310 of the computer system 300, that to the load current i₁₂ being above a first predetermined threshold 233 during a first predetermined time T₂₃₃; and controlling, by processing circuitry 310 of the computer system 300, the transistor device 210 to prevent electrical connection between the load 12, the at least one battery pack 100 and the electromechanical connector 25.

Example 19. A computer program product 500 comprising program code 710 for performing, when executed by processing circuitry 310, the computer implemented method 400 of any one of examples 16 to 18.

Example 20. A non-transitory computer-readable storage medium 600 comprising instructions 710, which when executed by processing circuitry 310, cause the processing circuitry 310 to perform the computer implemented method 400 of any one of examples 16 to 18.

Example 21. A sequential control circuitry 200 configured to: obtain a request 222 indicating that an electromechanical connector 25 arranged to selectively connect at least one battery pack 100 to a load 12 is to be actuated; and responsive to the request, cause control of a transistor device 210 configured to control an electrical connection between the load 12, the at least one battery pack 100 and the electromechanical connector 25 to prevent electrical connection between the electromechanical connector 25 and the load 12 and/or the at least one battery pack 100.

Example 22. The sequential control circuitry 200 of example 21, wherein the request 222 is a request to actuate the electromechanical connector 25 by opening the electromechanical connector 25.

Example 23. The sequential control circuitry 200 of example 21, wherein the request 222 is a request to actuate the electromechanical connector 25 by closing the electromechanical connector 25.

Example 24. The sequential control circuitry 200 of example 23, further configured to: obtain an indication of the electromechanical connector 25 being closed, and responsive to the indication, control the transistor device 210 to permit electrical connection between the load 12, the at least one battery pack 100 and the electromechanical connector 25.

Example 25. The sequential control circuitry 200 of example 24, further configured to configured control the transistor device 210 to permit electrical connection between the load 12, the at least one battery pack 100 and the electromechanical connector 25 by providing a pre-charge current to the load 12.

Example 26. The sequential control circuitry 200 of example 25, wherein the pre-charge current is provided by pulse width modulation (PWM) control of the transistor device 210.

Example 26. The sequential control circuitry 200 of example 25, wherein the pre-charge current is provided by linear control of the transistor device 210.

Example 27. The sequential control circuitry 200 of any one of example 24 to 26, wherein the processing circuitry 310 is further configured to: obtain an indication of the electromechanical connector 25 being closed by sensing a voltage level above a voltage threshold between the transistor device 210 and the electromechanical connector 25.

Example 28. The sequential control circuitry 200 of any one of examples 21 to 27, further configured to, and after controlling the transistor device 210, cause actuation of the electromechanical connector 25 in accordance with the request 222.

Example 29. A battery pack 100 comprising the sequential control circuitry 200 of any one of examples 21 to 28.

Example 30. An energy storage system 20 comprising the sequential control circuitry 200 of any one of examples 21 to 29.

Example 31. A vehicle 10 comprising the sequential control circuitry 200 of any one of examples 21 to 29.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A computer system comprising processing circuitry configured to:
obtain a request indicating that an electromechanical connector arranged to selectively connect at least one battery pack to a load is to be actuated;
responsive to the request, cause control of a transistor device configured to control an electrical connection between the load, the at least one battery pack and the electromechanical connector to prevent electrical connection between the electromechanical connector and the load and/or the at least one battery pack; and
after controlling the transistor device, cause actuation of the electromechanical connector in accordance with the request.

2. The computer system of claim 1, wherein the request is a request to actuate the electromechanical connector by closing the electromechanical connector and the processing circuitry is further configured to:
obtain an indication of the electromechanical connector being closed, and
responsive to the indication, control the transistor device to permit electrical connection between the load, the at least one battery pack and the electromechanical connector.

3. The computer system of claim 2, wherein the processing circuitry is further configured to:
obtain an indication of the electromechanical connector being closed by sensing a voltage level above a voltage threshold between the transistor device and the electromechanical connector.

4. The computer system of claim 1, wherein the processing circuitry is further configured to:
obtain a load current between the at least one battery pack and the load,
responsive to the load current being above a first predetermined threshold during a first predetermined time, control the transistor device to prevent electrical connection between the load, the at least one battery pack and the electromechanical connector.

5. The computer system of claim 1, wherein the transistor device is arranged between the electromechanical connector and the at least one battery pack, forming part of the at least one battery pack.

6. The computer system of claim 1, wherein the transistor device is arranged between the electromechanical connector and the load, forming part of the load.

7. The computer system of claim 1, wherein the request is a request to actuate the electromechanical connector by closing the electromechanical connector and the processing circuitry is further configured to: obtain an indication of the electromechanical connector being closed, and responsive to the indication, control the transistor device to permit electrical connection between the load, the at least one battery pack and the electromechanical connector; wherein the processing circuitry is further configured to: obtain an indication of the electromechanical connector being closed by sensing a voltage level above a voltage threshold between the transistor device and the electromechanical connector; wherein the processing circuitry is further configured to: obtain a load current between the at least one battery pack and the load, responsive to the load current being above a first predetermined threshold during a first predetermined time, control the transistor device to prevent electrical connection between the load, the at least one battery pack and the electromechanical connector; wherein the transistor device is arranged between the electromechanical connector and the at least one battery pack, forming part of the at least one battery pack; and wherein the battery pack is a propulsion battery pack for a vehicle.

8. A battery pack configured to be connected to a load via an electromechanical connector, the battery pack comprising the computer system of claim 1, at least one battery cell and a transistor device arranged to control an electrical connection between the load and the at least one battery cell.

9. The battery pack of claim 8, wherein the transistor device is configured as normally open.

10. The battery pack of claim 9, wherein the transistor device is configured to prevent electrical connection between the load and the at least one battery cell unless an indication of the electromechanical connector being closed is obtained.

11. An energy storage system configured to be connected to a load via an electromechanical connector, the energy storage system comprising:
at least one battery pack,
a transistor device configured to control an electrical connection between the load, the at least one battery pack and the electromechanical connector, and
the computer system of claim 1.

12. An energy storage system including the battery pack of claim 8.

13. A vehicle comprising the energy storage system of claim 11.

14. A computer implemented method comprising:
obtaining, by processing circuitry of a computer system, a request indicating that an electromechanical connector arranged to selectively connect at least one battery pack to a load is to be actuated;
responsive to the request, cause control of, by processing circuitry of the computer system, a transistor device configured to control an electrical connection between the load, the at least one battery pack and the electromechanical connector to prevent electrical connection between the load, the at least one battery pack and the electromechanical connector; and
after controlling the transistor device, causing actuation, by processing circuitry of the computer system, of the electromechanical connector in accordance with the request.

15. The computer implemented method of claim 14, wherein the request is a request to actuate the electromechanical connector by closing the electromechanical connector and the method further comprises:
obtaining, by processing circuitry of the computer system, an indication of the electromechanical connector being closed, and
responsive to the indication, controlling, by processing circuitry of the computer system, the transistor device to permit electrical connection between the load, the at least one battery pack and the electromechanical connector.

16. The computer implemented method of claim 14, further comprising: obtaining, by processing circuitry of the computer system, a load current between the at least one battery pack and the load, determining, by processing circuitry of the computer system, that to the load current being above a first predetermined threshold during a first predetermined time; and controlling, by processing circuitry of the computer system, the transistor device to prevent electrical connection between the load, the at least one battery pack and the electromechanical connector.

17. A computer program product comprising program code for performing, when executed by processing circuitry, the computer implemented method of claim 14.

18. A non-transitory computer-readable storage medium comprising instructions, which when executed by processing circuitry, cause the processing circuitry to perform the computer implemented method of claim 14.

19. A sequential control circuitry configured to: obtain a request indicating that an electromechanical connector arranged to selectively connect at least one battery pack to a load is to be actuated; and responsive to the request, cause control of a transistor device configured to control an electrical connection between the load, the at least one battery pack and the electromechanical connector to prevent electrical connection between the electromechanical connector and the load and/or the at least one battery pack.

20. The sequential control circuitry of claim 19, wherein the request is a request to actuate the electromechanical connector by opening the electromechanical connector.
